(19) United States
(12) Patent Application Publication
(10) Pub. No.: US 2025/0170675 A1
(43) Pub. Date: May 29, 2025

(54) LASER LIFT-OFF APPARATUS AND METHOD OF LIFTING-OFF SUBSTRATE USING THE SAME

(71) Applicant: Samsung Display Co., LTD., Yongin-si (KR)

(72) Inventors: Akifumi SANGU, Yongin-si (KR); Young Su CHAE, Yongin-si (KR); Cheol Ho PARK, Yongin-si (KR)

(21) Appl. No.: 18/777,190

(22) Filed: Jul. 18, 2024

(30) Foreign Application Priority Data
Nov. 27, 2023 (KR) 10-2023-0166455

(51) Int. Cl. B23K 26/067; B23K 26/06; B23K 101/36

(52) U.S. Cl. CPC B23K 26/067; B23K 26/0648; B23K 26/0652; B23K 2101/36

(57) ABSTRACT

In a laser lift-off apparatus configured to convert a first beam into a second beam having a width in a short axis direction and a long axis direction, the laser lift-off apparatus includes: a laser beam generator generating the first beam; a homogenizer homogenizing the first beam; and a wedge prism refracting at least a portion of the first beam passing through the homogenizer, wherein a beam profile of the second beam includes a first area and a second area having energy higher than that of the first area.

### CROSS-REFERENCE TO RELATED APPLICATION

The present application claims priority to and the benefit of Korean Patent Application No. 10-2023-0166455, filed on Nov. 27, 2023, in the Korean Intellectual Property Office, the entire disclosure of which is incorporated herein by reference.

### BACKGROUND

### 1. Field

Aspects of some embodiments of the present disclosure relate to a laser lift-off apparatus and a method of lifting-off a substrate using the same.

### 2. Description of the Related Art

A display device may be manufactured as a flexible device by using a flexible substrate having excellent flexibility.

However, because a flexible substrate generally has relatively high flexibility, it may desirably be supported during a manufacturing process of the display device. Therefore, after the flexible substrate is formed on a carrier substrate formed of a material such as glass, a process of manufacturing a flat panel display device may be performed and then the carrier substrate may be removed.

The carrier substrates may be removed by various methods, and studies for a laser lift-off method using a laser among the methods are actively ongoing.

The above information disclosed in this Background section is only for enhancement of understanding of the background and therefore the information discussed in this Background section does not necessarily constitute prior art.

### SUMMARY

Aspects of some embodiments of the present disclosure include a laser lift-off apparatus and a method of lifting-off a substrate using the same, in which reliability of a laser lift-off process is relatively improved.

The characteristics of embodiments according to the present disclosure are not limited to those mentioned above and additional characteristics of embodiments according to the present disclosure, which are not mentioned herein, will be more clearly understood by those skilled in the art from the following description of embodiments according to the present disclosure.

According to some embodiments of the present disclosure, a laser lift-off apparatus is configured to convert a first beam into a second beam having a width in a short axis direction and a long axis direction, and the laser lift-off apparatus includes: a laser beam generator generating the first beam; a homogenizer homogenizing the first beam; and a wedge prism refracting at least a portion of the first beam passing through the homogenizer, wherein a beam profile of the second beam includes a first area and a second area having energy higher than that of the first area.

According to some embodiments, the wedge prism includes a first wedge prism and a second wedge prism, which are spaced apart from each other in the long axis direction.

According to some embodiments, the second area includes a first sub-area and a second sub-area, which are located on their opposite sides with the first area interposed therebetween, the first sub-area is an area formed by the first beam passing through the first wedge prism, and the second sub-area is an area formed by the first beam passing through the second wedge prism.

According to some embodiments, the beam profile of the second beam includes a third area positioned to be opposite to the first area with the second area interposed therebetween, and the third area has energy lower than that of the first area.

According to some embodiments, an energy difference between the first area and the second area is the same as an energy difference between the first area and the third area.

According to some embodiments, a position of the second area in the beam profile of the second beam is determined by a position of an area where the first beam incident on the wedge prism overlaps the wedge prism.

According to some embodiments, energy intensity of the second area in the beam profile of the second beam is determined by a size of an area where the first beam incident on the wedge prism overlaps the wedge prism.

According to some embodiments, the laser lift-off apparatus may further comprise a telescope lens between the laser beam generator and the homogenizer, transmitting the first beam through enlargement or the same magnification.

According to some embodiments, the laser lift-off apparatus may further comprise a short axis slit between the homogenizer and the wedge prism, transmitting a portion of the first beam in the short axis direction.

According to some embodiments, the laser lift-off apparatus may further comprise a short axis Fourier lens between the homogenizer and the short axis slit, allowing the first beam transmitted through the telescope lens to be focused on the short axis slit along the short axis direction.

According to some embodiments, the laser lift-off apparatus may further comprise a long axis Fourier lens between the wedge prism and an image plane on which the second beam is incident, allowing the first beam transmitted through the telescope lens to be focused on the image plane.

According to some embodiments, the laser lift-off apparatus may further comprise a short axis projection lens between the wedge prism and the image plane on which the second beam is incident, adjusting a width of the first beam, which has passed through the short axis slit, in the short axis direction.

According to some embodiments, the laser lift-off apparatus may further comprise a beam cutter between the wedge prism and an image plane on which the second beam is incident, blocking a path of the first beam incident on an outer area of the second area.

According to some embodiments, the laser lift-off apparatus may further comprise a beam cancellation area outside the second area, wherein energy intensity of the beam cancellation area is lower than that of the second area.

According to some embodiments, a profile shape of the second beam in the first area and the second area is a flat top shape.

According to some embodiments of the present disclosure, in a method of lifting-off substrate, the method includes lifting-off a carrier substrate from a first substrate by irradiating a laser generated from a laser lift-off apparatus to a display device including the carrier substrate, the first substrate on the carrier substrate, a barrier layer on the first substrate, and a second substrate on the barrier layer, wherein the barrier layer is larger than the first substrate on a plane, the display device includes an active area in which pixels are located, and a protruded area in which the barrier layer does not overlap the first substrate, and energy intensity of the laser irradiated to the active area is lower than that of the laser irradiated to the protruded area.

According to some embodiments, the laser includes a first beam and a second beam, the laser lift-off apparatus converts the first beam into the second beam having a width in a short axis direction and a long axis direction, the laser lift-off apparatus includes: a laser beam generator generating the first beam; a homogenizer homogenizing the first beam; and a wedge prism refracting at least a portion of the first beam passing through the homogenizer, and a beam profile of the second beam includes a first area and a second area having energy higher than that of the first area.

According to some embodiments, the second beam of the first area is irradiated to the active area, and the second beam of the second area is irradiated to the protruded area.

According to some embodiments, a position of the second area in the beam profile of the second beam is determined by a position of an area where the first beam incident on the wedge prism overlaps the wedge prism.

According to some embodiments, energy intensity of the second area in the beam profile of the second beam is determined by a size of an area where the first beam incident on the wedge prism overlaps the wedge prism.

In the laser lift-off apparatus and the method of lifting-off a substrate using the same according to some embodiments of the present disclosure, reliability of a laser lifting-off process may be relatively improved.

The characteristics of embodiments according to the present disclosure are not limited to those mentioned above and more various characteristics are included in the following description of the present disclosure.

### BRIEF DESCRIPTION OF THE DRAWINGS

The above and other aspects and features of some embodiments of the present disclosure will become more apparent by describing in more detail aspects of some embodiments thereof with reference to the attached drawings, in which:

FIG. 1 is a cross-sectional view illustrating a display device during a manufacturing process according to some embodiments;

FIG. 2 is a plan view illustrating an area S1 of FIG. 1;

FIG. 3 is a plan view illustrating an area S2 of FIG. 2;

FIG. 4 is a schematic view illustrating an energy profile of a final laser beam applied to a carrier substrate and a panel substrate during a laser lift-off process using a laser lift-off apparatus according to some embodiments;

FIG. 5 is a schematic block diagram illustrating a laser lift-off apparatus according to some embodiments;

FIG. 6 is a schematic perspective view illustrating a laser lift-off apparatus according to some embodiments;

FIG. 7 is an enlarged view illustrating an area A of FIG. 6;

FIG. 8 is an enlarged view illustrating an area B of FIG. 6;

FIG. 9 is an enlarged view illustrating an area C of FIG. 6;

FIG. 10 is a schematic view illustrating an energy profile of a final laser beam of a laser lift-off apparatus according to some systems;

FIG. 11 is a schematic view illustrating an energy profile of a final laser beam of a laser lift-off apparatus according to some embodiments;

FIG. 12 is a schematic cross-sectional view illustrating a process of lifting off a carrier substrate and a panel substrate by using a laser lift-off apparatus according to some embodiments;

FIG. 13 is a schematic view illustrating a moving path of a laser beam in a long axis direction when a wedge prism according to some embodiments is located in different positions in a long axis direction;

FIG. 14 is a schematic view illustrating an illuminance distribution of a laser beam passing through a short axis slit according to some embodiments, and illustrates an example in which a wedge prism is located in different positions in a long axis direction;

FIG. 15 is a schematic view illustrating an energy profile of a final laser beam when a wedge prism according to some embodiments is located in different positions in a long axis direction;

FIG. 16 is a schematic view illustrating a moving path of a laser beam in a short axis direction when a wedge prism according to some embodiments is located in different positions in a short axis direction;

FIG. 17 is a schematic view illustrating an illuminance distribution of a laser beam passing through a short axis slit according to some embodiments, and illustrates an example in which a wedge prism is located in different positions in a short axis direction;

FIG. 18 is a schematic view illustrating an energy profile of a final laser beam when a wedge prism according to some embodiments is located in different positions in a short axis direction;

FIG. 19 is a schematic view illustrating a moving path of a laser beam in a long axis direction of a laser lift-off apparatus according to some embodiments; and

FIG. 20 is a schematic view illustrating an energy profile of a final laser beam of a laser lift-off apparatus according to some embodiments.

### DETAILED DESCRIPTION OF THE DISCLOSURE

Aspects of some embodiments of the present disclosure will now be described more fully hereinafter with reference to the accompanying drawings, in which aspects of some embodiments of the invention are shown. This invention may, however, be embodied in different forms and should not be construed as limited to the embodiments set forth herein. Rather, these embodiments are provided so that this disclosure will be thorough and complete, and will more fully convey the scope of embodiments according to the present disclosure to those skilled in the art.

It will also be understood that when a layer is referred to as being “on” another layer or substrate, it can be directly on the other layer or substrate, or intervening layers may also be present. The same reference numbers indicate the same components throughout the specification.

Hereinafter, aspects of some embodiments of the present disclosure will be described in more detail with reference to the accompanying drawings.

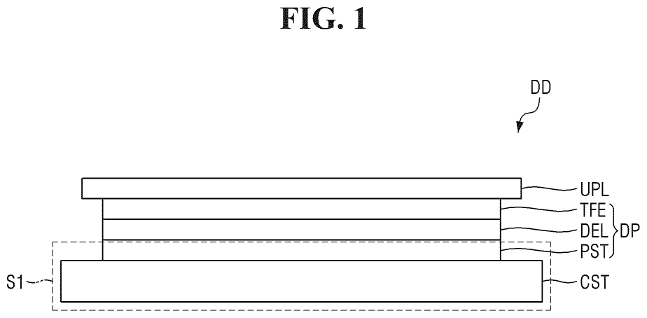

FIG. 1 is a cross-sectional view illustrating a display device during a manufacturing process according to some embodiments.

Referring to FIG. 1, a display device DD during a manufacturing process according to some embodiments may include a carrier substrate CST, a display panel DP, and an upper passivation layer UPL.

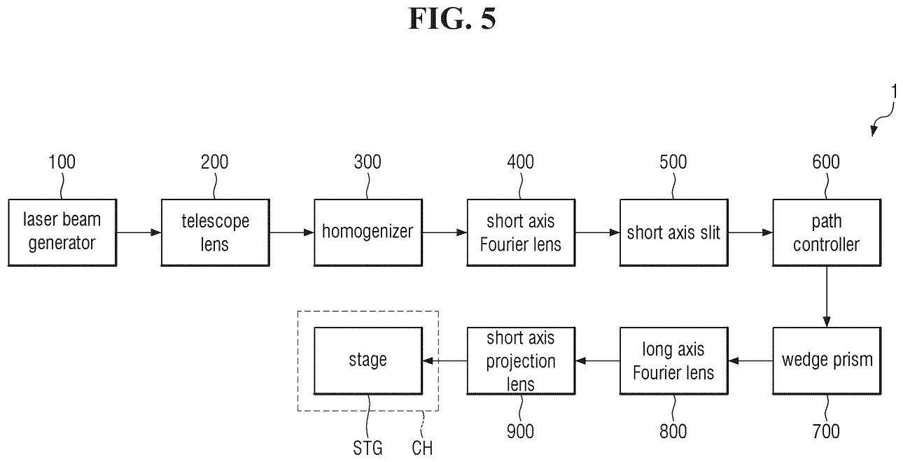

The carrier substrate CST may include a rigid material to serve as a support for supporting the display panel DP in the process of manufacturing the display device DD. The carrier substrate CST may be provided on a stage STG (see FIG. 5) in the process of manufacturing the display device DD.

The carrier substrate CST may include a transparent material because the carrier substrate CST needs to be capable of transmitting a laser during a lift-off process using the laser. For example, the carrier substrate CST may be made of glass containing SiO₂ as a main component. For another example, the carrier substrate CST may include at least one of borosilicate glass, fused silica glass or quartz glass.

When the display device DD is completed, the carrier substrate CST may be lifted off from the panel substrate PST, and may be removed from the display device DD.

The display panel DP may include a panel substrate PST, a display element layer DEL and an encapsulation layer TFE.

The panel substrate PST may be located on the carrier substrate CST. According to some embodiments, the panel substrate PST may be a flexible substrate, but embodiments according to the present disclosure are not limited thereto.

In some embodiments, the panel substrate PST may include a plastic material. For example, the panel substrate PST may be formed of polyamide or polyimide that has excellent heat resistance to endure a high temperature process such as a low-temperature temperature polysilicon (LTPS) manufacturing process and at the same time is flexible when processed in the form of a film. The panel substrate PST may be formed by coating a polyamide or polyimide solution on the carrier substrate CST by a spin coating method and then hardening the polyamide or polyimide solution, or may be formed by attaching or laminating a film-type polyamide or polyimide substrate to the carrier substrate by an adhesive material.

The display element layer DEL may be located on the panel substrate PST. The display element layer DEL may include a light emitting element and a circuit element for driving the light emitting element.

The encapsulation layer TFE may be located on the display device layer DEL. The encapsulation layer TFE may seal the display device layer DEL. The encapsulation layer TFE may be in the form of a thin film or a multi-layer. For example, the encapsulation layer TFE may be a thin film encapsulation layer. The encapsulation layer TFE may have a structure in which a film made of an inorganic material such as silicon oxide (SiOx) or silicon nitride (SiNx) and a film made of an organic material such as epoxy and polyimide are alternately grown, but embodiments according to the present disclosure are not limited thereto. The encapsulation layer TFE may include a film made of low melting glass.

The upper passivation layer UPL may be located on the encapsulation layer TFE. The upper passivation layer UPL may prevent or reduce damage to the encapsulation layer TFE while the panel substrate PST is being lifted off from the carrier substrate CST. The upper passivation layer UPL may be removed after the panel substrate PST is lifted off from the carrier substrate CST.

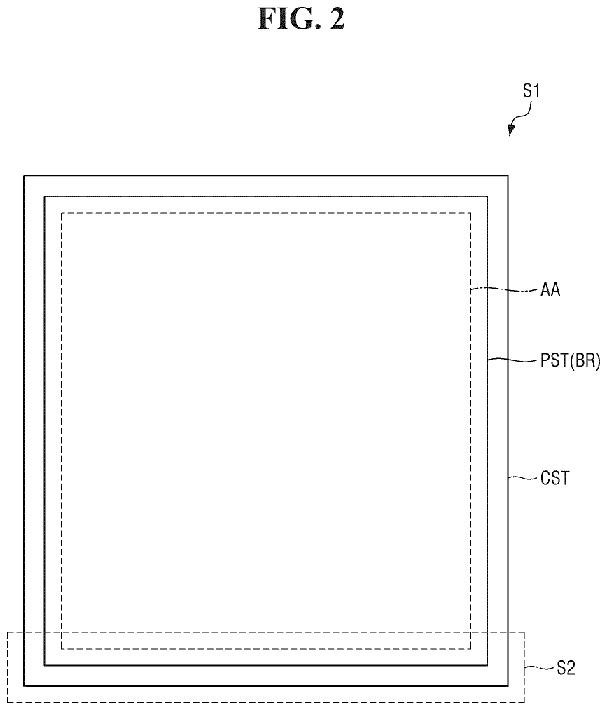

FIG. 2 is a plan view illustrating an area S1 of FIG. 1.

Referring to FIG. 2 in addition to FIG. 1, the display device DD may include an active area AA. The active area AA may be an area in which a plurality of pixels are located. The active area AA may be an area for displaying an image. The active area AA may be referred to as a display area.

In some embodiments, the periphery of the active area AA may be positioned to be inner than the periphery of the panel substrate PST. A size of the panel substrate PST may be larger than that of the active area AA on the plane. The remaining area of the panel substrate PST except the active area AA may be a non-active area or a non-display area.

In some embodiments, the periphery of the panel substrate PST may be positioned to be inner than the periphery of the carrier substrate CST. A size of the carrier substrate CST may be larger than that of the panel substrate PST on the plane.

The carrier substrate CST may include a boundary area BR. The boundary area BR may be a boundary of an area in which the panel substrate PST and the carrier substrate CST overlap each other and an area in which they start to non-overlap each other. For example, based on the boundary area BR, the panel substrate PST may be located inside the boundary area BR, and the panel substrate PST may not be located outside the boundary area BR.

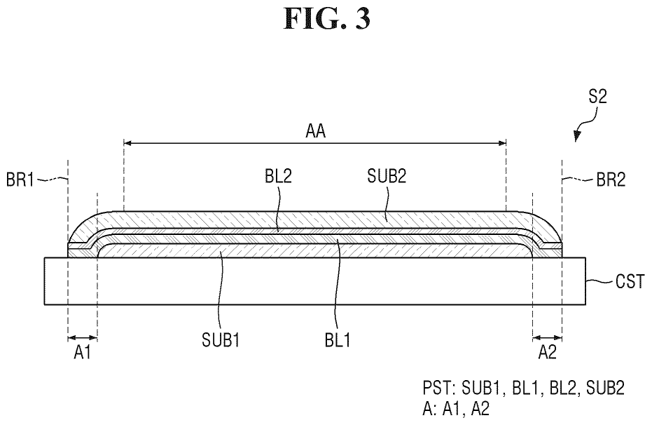

FIG. 3 is a plan view illustrating an area S2 of FIG. 2.

Referring to FIG. 3 in addition to FIGS. 1 and 2, the panel substrate PST may include a first substrate SUB1, a first barrier layer BL1, a second barrier layer BL2, and a second substrate SUB2. The second substrate SUB2 is shown as being located on the second barrier layer BL2, but embodiments according to the present disclosure are not limited thereto. The order of stacking the second barrier layer BL2 and the second substrate SUB2 may be changed. For example, the second barrier layer BL2 may be located on the second substrate SUB2.

The first substrate SUB1 may be located on the carrier substrate CST. The first substrate SUB1 may have an area smaller than that of the carrier substrate CST. Therefore, the first substrate SUB1 may non-overlap at least a portion of the carrier substrate CST.

According to some embodiments, the first substrate SUB1 may include an organic material. For example, the first substrate SUB1 may include at least one of a polyamide resin or a polyimide resin, but embodiments according to the present disclosure are not limited thereto.

The first barrier layer BL1 may be located on the first substrate SUB1. The first barrier layer BL1 may have an area larger than that of the first substrate SUB1. Therefore, the first barrier layer BL1 may entirely cover the first substrate SUB1. The first barrier layer BL1 may be in contact with at least a portion of the carrier substrate CST.

According to some embodiments, the first barrier layer BL1 may include an inorganic material. For example, the first barrier layer BL1 may include one or more from a group of silicon nitride (SiNx), aluminum nitride (AlNx), titanium nitride (TiNx), silicon oxide (SiOx), aluminum oxide (AIOx), titanium oxide (TiOx), silicon oxycarbide (SiOxCy) and silicon oxynitride (SiOxNy), but embodiments according to the present disclosure are not limited thereto.

The second barrier layer BL2 may be located on the first barrier layer BL1. The second barrier layer BL2 may have an area larger than that of the first barrier layer BL1. Therefore, the second barrier layer BL2 may entirely cover the first barrier layer BL1.

According to some embodiments, the second barrier layer BL2 may include an inorganic material. The second barrier layer BL2 may include one or more of the materials described above with reference to the first barrier layer BL1, but embodiments according to the present disclosure are not limited thereto.

The second substrate SUB2 may be located on the second barrier layer BL2. The second substrate SUB2 may have an area larger than that of the first substrate SUB1. The second substrate SUB2 and the first substrate SUB1 may have end portions that do not overlap each other. When the second substrate SUB2 has an area larger than that of the first substrate SUB1, the second substrate SUB2 may form a protruded area A more protruded in a longitudinal direction of the first substrate SUB1 than the first substrate SUB1.

The protruded area A may include a first protruded area A1 and a second protruded area A2. The first protruded area A1 may be located on one side of the active area AA, and the second protruded area A2 may be located on the other side of the active area AA.

According to some embodiments, the second substrate SUB2 may include an organic material. The second substrate SUB2 may include one or more of the materials described above with reference to the first substrate SUB1, but embodiments according to the present disclosure are not limited thereto.

The boundary area BR may include a first boundary area BR1 and a second boundary area BR2. The first boundary area BR1 may be located on one side of the active area AA, and the second boundary area BR2 may be located on the other side of the active area AA.

The protruded area A may overlap a portion of each of the first barrier layer BL1 and the second barrier layer BL2, which are located between the carrier substrate CST and the second substrate SUB2.

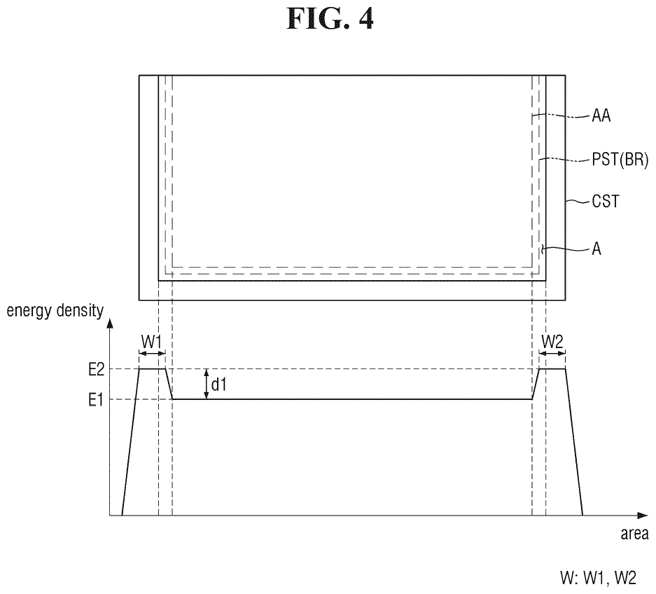

FIG. 4 is a schematic view illustrating an energy profile of a final laser beam applied to a carrier substrate and a panel substrate during a laser lift-off process using a laser lift-off apparatus according to some embodiments.

Referring to FIG. 4 in addition to FIGS. 1 to 3, in order for the carrier substrate CST to be lifted off from the panel substrate PST, the laser lift-off apparatus 1 (see FIG. 5) needs to apply appropriate energy to an area where the panel substrate PST and the carrier substrate CST are in contact with each other. For example, when the laser lift-off apparatus 1 (see FIG. 5) does not apply appropriate energy, the first substrate SUB1 may not be properly lifted off, whereby the configuration of the display device DD may be damaged.

Meanwhile, because pixels are located in the active area AA, the active area AA needs to be lifted off with relatively lower energy than the area other than the active area AA to prevent or reduce damage to the pixels.

For example, when the laser lift-off apparatus 1 (see FIG. 5) applies high energy to the active area AA, the first substrate SUB1 may be damaged by high energy of the laser beam. In this case, an adhesive force of the components located on the first substrate SUB1 may be weakened, and the encapsulation layer TFE may be lifted off.

Therefore, the active area AA needs to be lifted off using a laser beam having relatively low energy among laser beams incident on the panel substrate PST. The laser lift-off apparatus 1 (see FIG. 5) according to some embodiments, which will be described later, may apply appropriately low energy to the active area AA. Therefore, the risk of lifting off the encapsulation layer TFE may be relatively reduced.

Meanwhile, because the protruded area A is an area in which the first barrier layer BL1 and the second barrier layer BL2 are located between the carrier substrate CST and the second substrate SUB2, energy intensity of the laser beam reaching the second substrate SUB2 may be relatively reduced by the first barrier layer BL1 and the second barrier layer BL2.

Therefore, the protruded area A needs to be lifted off with relatively higher energy than the active area AA. When high energy is not applied to the protruded area A, a portion of the protruded area A of the second substrate SUB2 may not be lifted off. In this case, when a lift-off blade is used for complete lift-off, the first substrate SUB1 may be damaged as the lift-off blade passes between the carrier substrate CST and the first substrate SUB1.

The laser lift-off apparatus 1 according to some embodiments, which will be described later, may apply appropriately high energy to the protruded area A. Therefore, reliability of the laser lift-off process may be relatively improved.

For example, as shown in FIG. 4, the active area AA may be lifted off by a laser beam having first energy E1. In the active area AA, the laser beam may have first energy E1 that is generally uniform.

The protruded area A and the boundary area BR may be lifted off by a laser beam having second energy E2. The laser beam may have second energy E2, which is generally uniform, in the vicinity of the protruded area A. The laser beam may have a first area W1 and a second area W2, in which the second energy E2 is constant in an energy density graph for each area.

The first energy E1 may be lower than the second energy E2. The first energy E1 and the second energy E2 may have an energy difference (e.g., a set or predetermined energy difference) d1.

The laser lift-off apparatus 1 according to some embodiments, which will be described later, may inject appropriate energy for each area as described above. A method of adjusting energy of the laser beam incident for each area by the laser lift-off apparatus 1 will be described below with reference to FIG. 5 and the like.

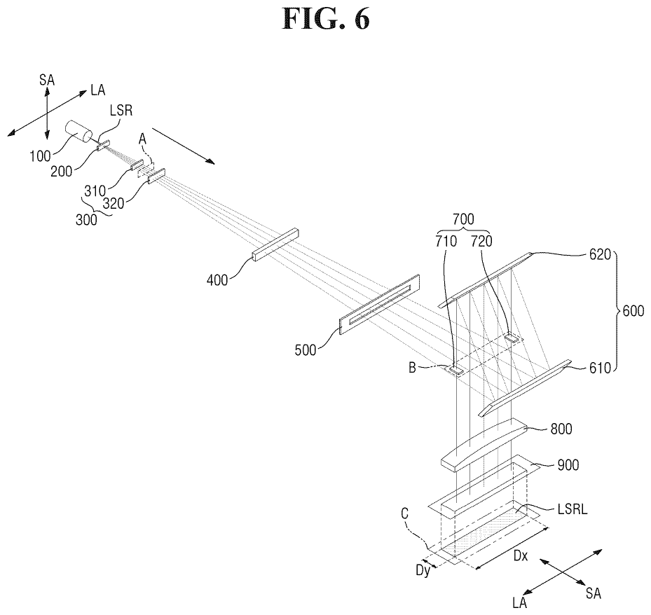

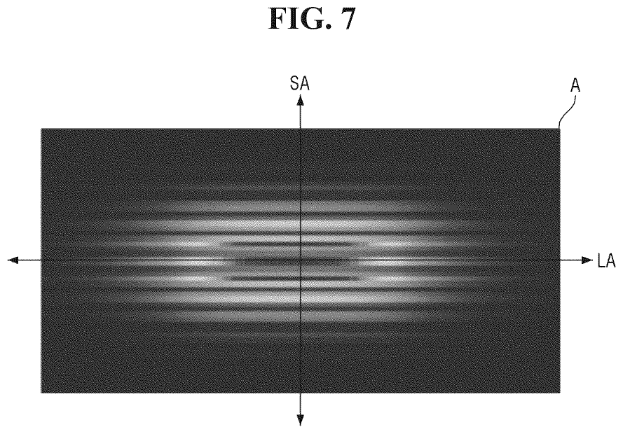

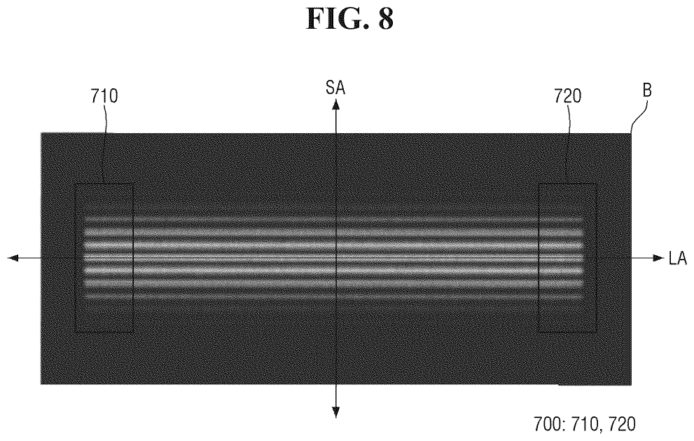

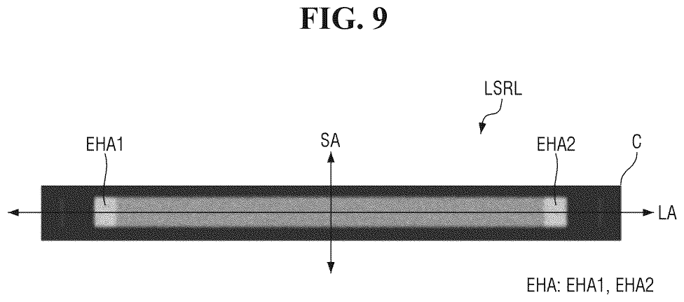

FIG. 5 is a schematic block diagram illustrating a laser lift-off apparatus according to some embodiments. FIG. 6 is a schematic perspective view illustrating a laser lift-off apparatus according to some embodiments. FIG. 7 is an enlarged view illustrating an area A of FIG. 6. FIG. 8 is an enlarged view illustrating an area B of FIG. 6. FIG. 9 is an enlarged view illustrating an area C of FIG. 6.

Referring to FIGS. 5 to 9, the laser lift-off apparatus 1 according to some embodiments may be an apparatus capable of lifting off the carrier substrate CST from the panel substrate PST by using a laser. For example, the laser lift-off apparatus 1 may be an excimer laser peeler (ELP), but embodiments according to the present disclosure are not limited thereto.

The laser lift-off apparatus 1 may include a laser beam generator 100, a telescope lens 200, a homogenizer 300, a short axis Fourier lens 400, a short axis slit 500, a path controller 600, a wedge prism 700, a long axis Fourier lens 800, a short axis projection lens 900, and a stage STG.

The laser beam generator 100 may generate a laser beam LSR. According to some embodiments, the laser beam generator 100 may generate the laser beam LSR by using an excimer laser, but embodiments according to the present disclosure are not limited thereto. According to some embodiments, the laser beam generator 100 may generate the laser beam LSR by using a solid state laser.

The laser beam generator 100 may include at least one light source. The light source may generate the laser beam LSR by using a laser. The laser beam LSR may be generated in the form of Gaussian. The laser beam LSR may have a wavelength ranging from 300 nm to 410 nm, but embodiments according to the present disclosure are not limited thereto.

The laser beam LSR may be converted into a final laser beam LSRL through several optical devices. The final laser beam LSRL may have a line shape having a long axis length Dx in the long axis direction LA and a short axis length Dy in the short axis direction SA.

Hereinafter, several optical devices will be described. The optical device may include a telescope lens 200, a homogenizer 300, a short axis Fourier lens 400, a short axis slit 500, a path controller 600, a wedge prism 700, a long axis Fourier lens 800, and a short axis projection lens 900.

In the drawing, the embodiments in which the telescope lens 200, the homogenizer 300, the short axis Fourier lens 400, the short axis slit 500, the path controller 600, the wedge prism 700, the long axis Fourier lens 800 and the short axis projection lens 900 are implemented as lenses is illustrated by way of example, but embodiments according to the present disclosure are not limited thereto. For example, the telescope lens 200, the homogenizer 300, the short axis Fourier lens 400, the short axis slit 500, the path controller 600, the wedge prism 700, the long axis Fourier lens 800 and the short axis projection lens 900 may be implemented using at least one of a lens or a mirror.

The telescope lens 200 may transmit the laser beam LSR incident on the telescope lens 200 through enlargement or transmit the laser beam LSR at the same magnification. According to some embodiments, the telescope lens 200 may include a first telescope lens that adjusts the degree of enlargement (or magnification) in the long axis direction LA and a second telescope that adjusts the degree of enlargement (or magnification) in the short axis direction SA, but embodiments according to the present disclosure are not limited thereto. One telescope lens 200 may adjust both the degree of enlargement (or magnification) in the long axis direction LA and the degree of enlargement (or magnification) in the short axis direction SA.

The homogenizer 300 may convert a laser beam LSR having an energy density of a Gaussian distribution into a laser beam LSR having a uniform energy density in the long axis direction LA and the short axis direction SA. The homogenizer 300 may include at least one of a saw tooth lens, a light guide made of mirrors, or a Fly's eye lens.

In some embodiments, the homogenizer 300 may include a short axis homogenizer 310 and a long axis homogenizer 320. The short axis homogenizer 310 may generate a laser beam LSR having a uniform energy density in the short axis direction SA, and the long axis homogenizer 320 may generate a laser beam LSR having a uniform energy density in the long axis direction LA.

FIG. 7 illustrates an illuminance distribution of the laser beam LSR passing through the short axis homogenizer 310. As shown in FIG. 7, the laser beam LSR passing through the short axis homogenizer 310 may have a uniform energy density in the short axis direction SA. For example, the laser beam LSR passing through the short axis homogenizer 310 may be divided into a plurality of laser beams LSR spaced apart from each other at constant intervals along the short axis direction SA. The plurality of laser beams LSR spaced apart from each other at constant intervals along the short axis direction SA may have a uniform energy density.

According to some embodiments, the laser beam LSR passing through the long axis homogenizer 320 may have a uniform energy density in the long axis direction. For example, the laser beam LSR passing through the long axis homogenizer 320 may be divided into a plurality of laser beams LSR spaced apart from each other at constant intervals along the long axis direction LA. The plurality of laser beams LSR spaced apart from each other at constant intervals along the long axis direction LA may have a uniform energy density.

In the drawing, the laser beam LSR is shown as being passing through the short axis homogenizer 310 and then passing through the long axis homogenizer 320, but embodiments according to the present disclosure are not limited thereto. For example, the short axis homogenizer 310 and the long axis homogenizer 320 may be located in a reverse order. In this case, the laser beam LSR may pass through the long axis homogenizer 320, and then may pass through the short axis homogenizer 310.

The short axis Fourier lens 400 may change a path of the laser beam LSR so that the laser beam LSR, which moves by being diffused along the short axis direction SA through the short axis homogenizer 310, may be focused on the short axis slit 500. In some embodiments, the short axis Fourier lens 400 may include a cylindrical convex lens, but embodiments according to the present disclosure are not limited thereto.

The short axis slit 500 may determine a width of the laser beam LSR in the short axis direction SA. For example, the short axis slit 500 may include an opening having a short width in the short axis direction SA and a long width in the long axis direction LA. The width of the laser beam LSR, which has passed through the opening, in the short axis direction SA may be limited to the same size as the width of the opening.

The path controller 600 may control a moving distance and a moving direction of the laser beam LSR in accordance with a design structure of the laser lift-off apparatus 1. In some embodiments, the path controller 600 may include at least one reflective mirror. For example, the path controller 600 may include a first mirror 610 and a second mirror 620, but embodiments according to the present disclosure are not limited thereto. Various modifications may be made in the number and position of the reflective mirrors.

The laser beam LSR may be reflected by the mirror so that its moving direction may be changed. The moving distance of the laser beam LSR may be increased even in a narrow space in accordance with the degree in which the moving direction is changed. Therefore, the degree of focus and diffusion of the laser beam LSR may vary.

In some embodiments, the path controller 600 may be omitted.

The wedge prism 700 may refract the laser beam LSR that has passed therethrough. The wedge prism 700 may refract at least a portion of the laser beam LSR that has passed through the short axis slit 500 to increase energy density in a specific area of the final laser beam LSRL.

FIG. 8 is a view illustrating an illuminance distribution of the laser beam LSR that has passed through the short axis slit 500. As shown in FIG. 8, the wedge prism 700 may overlap at least a portion of the laser beam LSR that has passed through the short axis slit 500. For example, the wedge prism 700 may include a first wedge prism 710 and a second wedge prism 720. The first wedge prism 710 and the second wedge prism 720 may be spaced apart from each other in the long axis direction LA.

FIG. 9 is a view illustrating an illuminance distribution of the final laser beam LSRL. After the laser beam LSR passes through the wedge prism 700, the final laser beam LSRL may include an energy enhancement area EHA in the energy profile. The energy enhancement area EHA may be a portion having a higher energy density than other areas of the final laser beam LSRL.

The energy enhancement area EHA may include a first energy enhancement area EHA1 and a second energy enhancement area EHA2. The first energy enhancement area EHA1 may be an area in which energy density is increased by the laser beam LSR passing through the first wedge prism 710, and the second energy enhancement area EHA2 may be an area in which energy density is increased by the laser beam LSR passing through the second wedge prism 720.

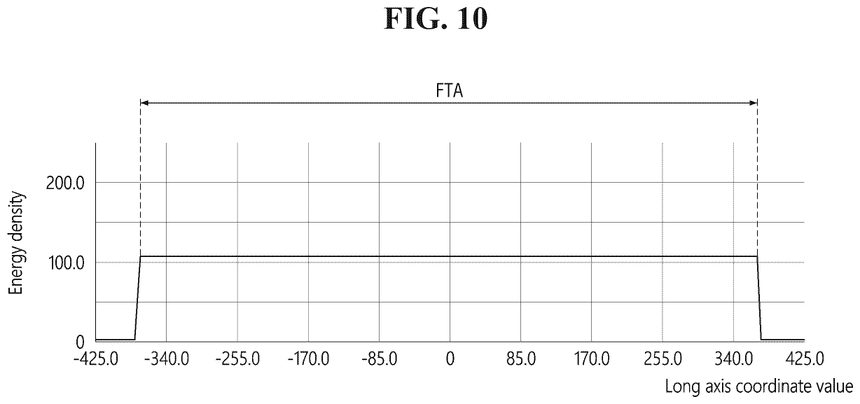

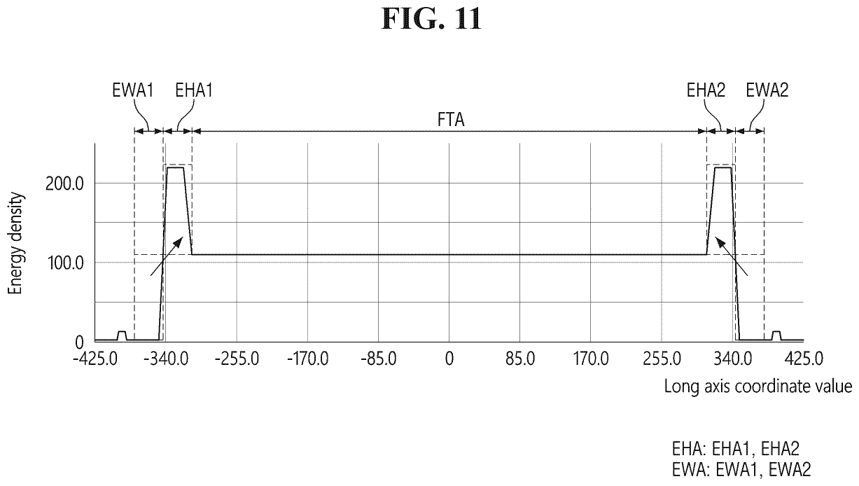

A method of forming the energy reinforcement area EHA by the wedge prism 700 will be described later with reference to FIGS. 10 and 11.

The long axis Fourier lens 800 may change the path of the laser beam LSR so that the laser beam LSR, which moves by being diffused along the long axis direction LA through the long axis homogenizer 320, may be focused on an image plane. In some embodiments, the long axis Fourier lens 800 may include a cylindrical convex lens, but embodiments according to the present disclosure are not limited thereto.

The short axis projection lens 900 may adjust the width of the laser beam LSR, which has passed through the short axis slit 500, in the short axis direction SA. The short axis projection lens 900 may maintain the shape of the laser beam LSR passing through the short axis slit 500, but may adjust the width of the laser beam LSR in the short axis direction SA.

In the drawing, the laser beam LSR is shown as being passing through the long axis Fourier lens 800 and then passing through the short axis projection lens 900, but embodiments according to the present disclosure are not limited thereto. For example, the long axis Fourier lens 800 and the short axis projection lens 900 may be arranged in a reverse order. In this case, the laser beam LSR may pass through the short axis projection lens 900, and then may pass through the long axis Fourier lens 800.

The final laser beam LSRL may be incident on the image plane. As described above, the final laser beam LSRL may have a long axis length Dx in the long axis direction LA and a short axis length Dy in the short axis direction SA. The final laser beam LSRL may include an energy enhancement area EHA. The image plane may be positioned on the stage STG.

The stage STG may provide a seating space in which a target object may be located during a laser lift-off process. The stage STG may be positioned in a chamber CH. The chamber CH may provide an internal space for performing the laser lift-off process. For example, the chamber CH may maintain a state such as a vacuum environment according to the process and blocking of the outside air.

Hereinafter, a method of forming the energy enhancement area EHA of the final laser beam LSRL will be described.

FIG. 10 is a schematic view illustrating an energy profile of a final laser beam of a laser lift-off apparatus according to some systems. FIG. 11 is a schematic view illustrating an energy profile of a final laser beam of a laser lift-off apparatus according to some embodiments.

Referring to FIGS. 10 and 11 in addition to FIGS. 5 to 9, the laser lift-off apparatus 1 according to the related-art embodiment may not include the wedge prism 700. The laser lift-off apparatus 1 according to the present embodiments may include the wedge prism 700.

In the laser lift-off apparatus 1 according to the related-art embodiment and embodiments according to the present disclosure, an energy profile shape of the final laser beam LSRL may be a flat top type shape in most areas. Because the energy profile shape of the final laser beam LSRL is a flat top type, uniform energy may be applied to most areas of the target object to which the final laser beam LSRL is irradiated.

Meanwhile, the laser lift-off apparatus 1 according to the related-art embodiment that does not include the wedge prism 700 may not include an energy enhancement area EHA. The laser lift-off apparatus 1 according to some embodiments may include an energy enhancement area EHA.

In the laser lift-off apparatus 1 according to some embodiments, the final laser beam LSRL may include an energy weakening area EWA in an energy profile. The energy weakening area EWA may be a portion having an energy density lower than that of other areas of the final laser beam LSRL.

The energy weakening area EWA may include a first energy weakening area EWA1 and a second energy weakening area EWA2. The first energy weakening area EWA1 may be an area in which an energy density is lowered by the laser beam LSR passing through the first wedge prism 710, and the second energy weakening area EWA2 may be an area in which an energy density is lowered by the laser beam LSR passing through the second wedge prism 720.

The final laser beam LSRL of the laser lift-off apparatus 1 according to the related-art embodiment may have substantially the same energy density in a flat top area FTA. The flat top area FTA may be an area having an energy density by the laser beam LSR that does not pass through the wedge prism 700.

On the other hand, in the laser lift-off apparatus 1 according to some embodiments, the final laser beam LSRL may have a higher energy density in the energy enhancement area EHA than in the flat top area FTA, and may have a lower energy density in the energy weakening area EWA than in the flat top area FTA.

For example, the wedge prism 700 may refract the laser beam LSR that should be incident on the energy weakening area EWA so that the laser beam LSR may be incident on the energy enhancement area EHA, whereby the laser beam LSR that has passed through the wedge prism 700 may be focused on the energy enhancement area EHA. Therefore, the energy density of the energy enhancement area EHA may be higher than that of the flat top area FTA as much as a difference between the energy density in the flat top area FTA and the energy density in the energy weakening area EWA.

The laser lift-off apparatus 1 according to some embodiments may perform the laser lift-off process by using the final laser beam LSRL including the energy enhancement area, thereby improving reliability of the laser lift-off process.

Hereinafter, the laser lift-off process performed using the final laser beam LSRL including the energy enhancement area EHA will be described.

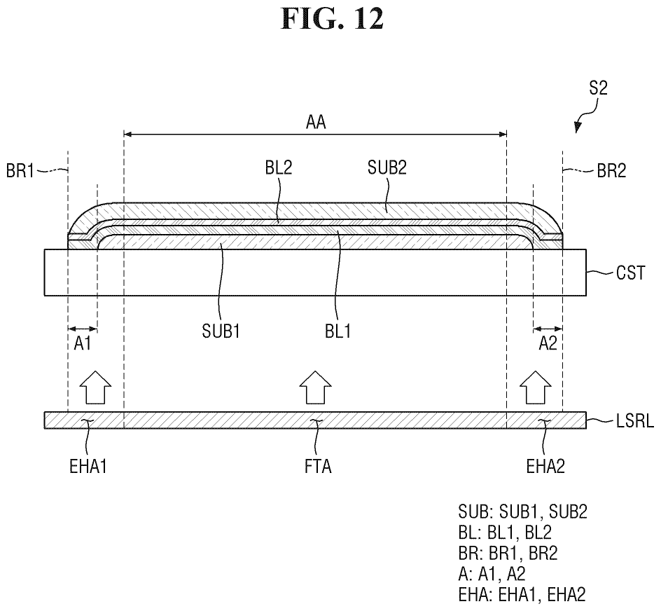

FIG. 12 is a schematic cross-sectional view illustrating a process of lifting off a carrier substrate and a panel substrate by using a laser lift-off apparatus according to some embodiments.

Referring to FIG. 12 in addition to FIGS. 5 to 11, the carrier substrate CST located in the active area AA may be lifted off by the final laser beam LSRL having the energy density of the flat top area FTA. As described above, because pixels are located in the active area AA, the active area AA may be lifted off by the final laser beam LSRL having the energy density of the flat top area FTA having relatively low energy. Therefore, weakening of the adhesive force of the components located on the first substrate SUB1 may be prevented or reduced, and damage to the components may be minimized or reduced.

The protruded area A and the boundary area BR may be lifted off by the final laser beam LSRL having the energy density of the energy enhancement area EHA. As described above, because the barrier layer BL is located between the carrier substrate CST and the second substrate SUB2, the protruded area A may be lifted off by the final laser beam LSRL having the energy density of the energy enhancement area EHA having relatively high energy. Therefore, sufficient energy may be applied to the protruded area A, so that the carrier substrate CST may be completely lifted off. As a result, a separate lift-off blade is not used, and thus damage to the first substrate SUB1 may be minimized or reduced. Therefore, reliability of the laser lift-off process may be relatively improved.

Hereinafter, a method of adjusting the position of the energy enhancement area EHA and the size of the energy density in accordance with the position of the wedge prism 700 will be described.

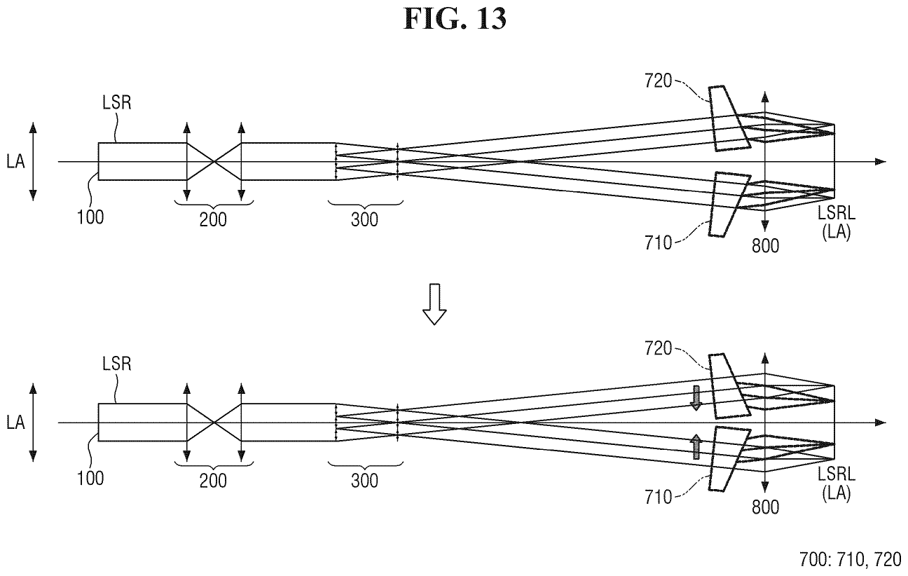

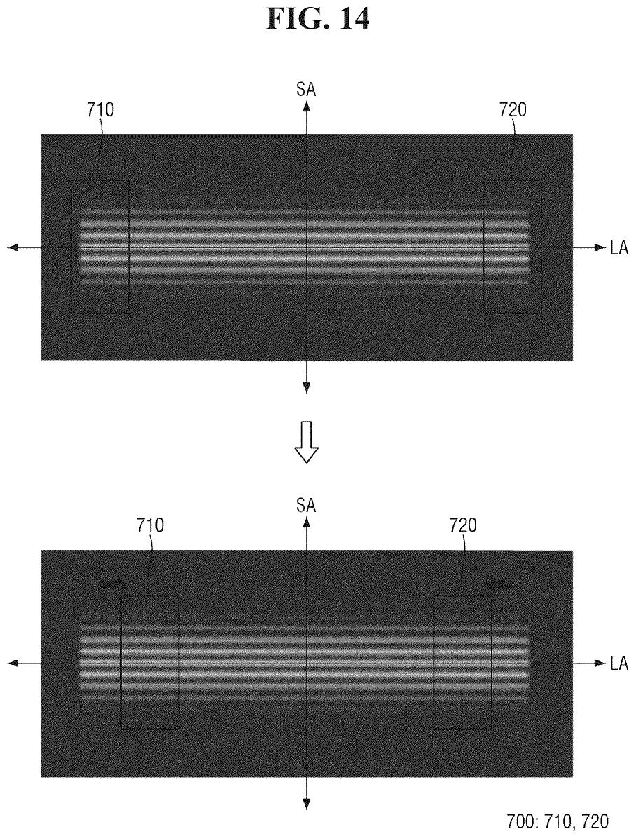

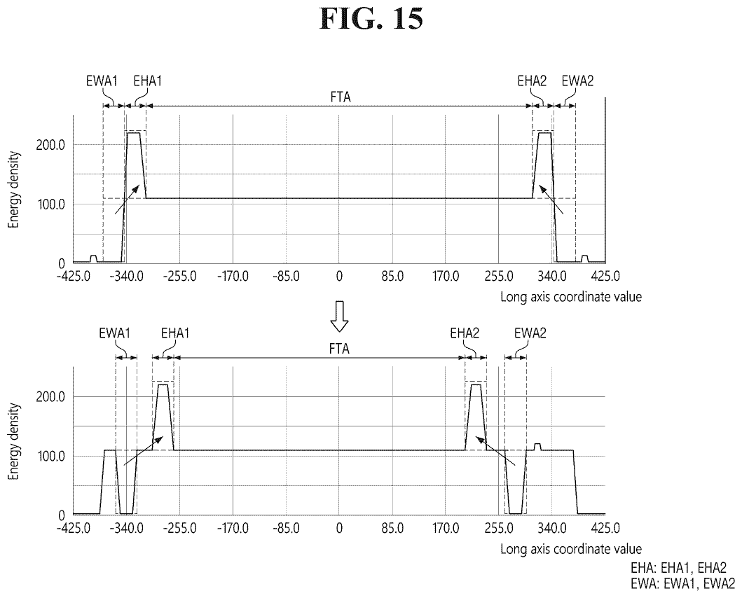

FIG. 13 is a schematic view illustrating a moving path of a laser beam in a long axis direction when a wedge prism according to some embodiments is located in different positions in a long axis direction. FIG. 14 is a schematic view illustrating an illuminance distribution of a laser beam passing through a short axis slit according to some embodiments, and illustrates an example in which a wedge prism is located in different positions in a long axis direction. FIG. 15 is a schematic view illustrating an energy profile of a final laser beam when a wedge prism according to some embodiments is located in different positions in a long axis direction.

Referring to FIGS. 13 to 15 in addition to FIG. 12, FIG. 13 is a view illustrating a moving path of the laser beam LSR in the long axis direction LA. FIG. 14 is a view illustrating a state that the wedge prism 700 moves in the long axis direction LA. FIG. 15 is a view illustrating a shape change in the energy profile of the final laser beam LSRL when the wedge prism 700 moves in the long axis direction LA.

As shown in FIGS. 13 and 14, when the wedge prism 700 moves toward the center in the long axis direction LA, the positions of the energy enhancement area EHA and the energy-weakening area EWA may also move toward the center as shown in FIG. 15.

For example, when the first wedge prism 710 and the second wedge prism 720 move toward the center so that they are arranged to be close to each other in the long axis direction LA, the first energy enhancement area EHA1 and the second energy enhancement area EHA2 may also move toward the center so that they are arranged to be close to each other. The first energy weakening area EWA1 and the second energy weakening area EWA2 may also move toward the center so that they are arranged to be close to each other.

Because the active area AA, the protruded area A and the boundary area BR are different from one another in their sizes and positions for each display device DD to be manufactured, the position of the energy enhancement area EHA needs to be changed to be matched with the display device DD to be manufactured.

The laser lift-off apparatus 1 according to some embodiments may easily adjust the position of the energy enhancement area EHA by adjusting the position of the wedge prism 700 in the long axis direction LA. Therefore, the position of the energy enhancement area EHA may be adjusted by a method such as adjusting the position of the wedge prism 700 in the long axis direction LA by providing a separate driving unit without replacing the wedge prism 700 for each display device DD to be manufactured.

Meanwhile, according to some embodiments, the width of the energy reinforcement area EHA may be adjusted by adjusting a refractive index of the wedge prism 700. For example, the refractive index of the wedge prism 700 may be adjusted by adjusting angles of an incident surface and an emission surface of the wedge prism 700. Therefore, the width of the energy enhancement area EHA may be also adjusted.

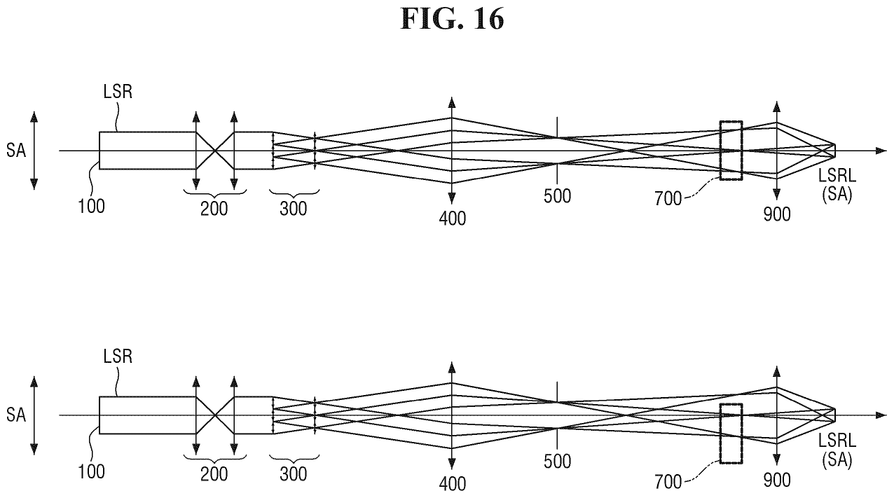

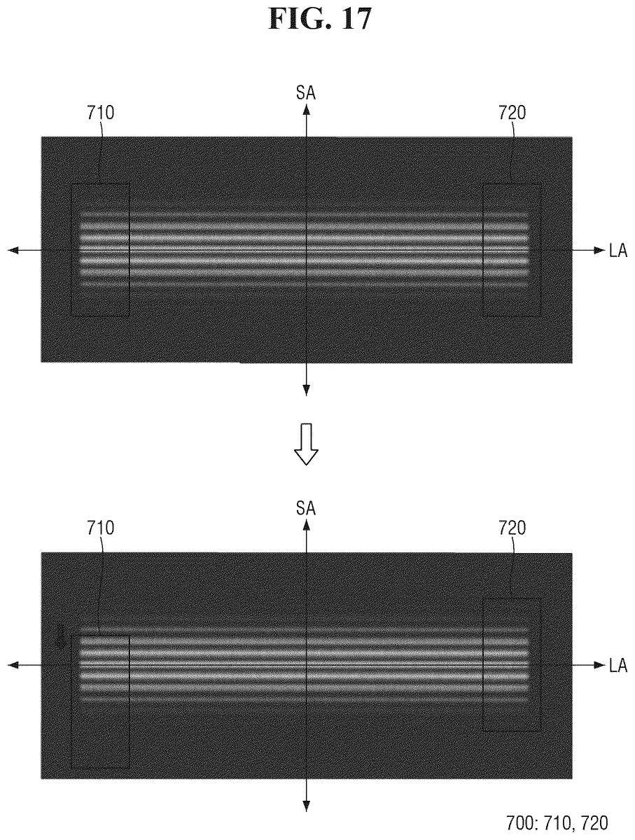

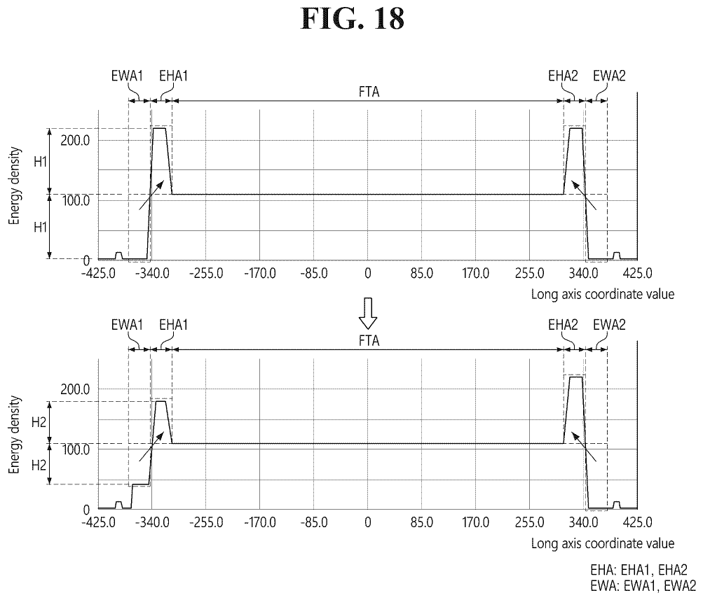

FIG. 16 is a schematic view illustrating a moving path of a laser beam in a short axis direction when a wedge prism according to some embodiments is located in different positions in a short axis direction. FIG. 17 is a schematic view illustrating an illuminance distribution of a laser beam passing through a short axis slit according to some embodiments, and illustrates an example in which a wedge prism is located in different positions in a short axis direction. FIG. 18 is a schematic view illustrating an energy profile of a final laser beam when a wedge prism according to some embodiments is located in different positions in a short axis direction.

Referring to FIGS. 16 to 18 in addition to FIG. 12, FIG. 16 is a view illustrating a moving path of the laser beam LSR in the short axis direction SA. FIG. 17 is a view illustrating a state that the wedge prism 700 moves in the short axis direction SA. FIG. 18 is a view illustrating a shape change in the energy profile of the final laser beam LSRL when the wedge prism 700 moves in the short axis direction SA.

As shown in FIGS. 16 and 17, when the wedge prism 700 moves toward the edge in the short axis direction SA, the size in the energy density of the energy enhancement area EHA and the energy weakening area EWA may vary as shown in FIG. 18.

For example, in the drawing, the case that the first wedge prism 710 moves toward the edge in the short axis direction SA and the second wedge prism 720 does not move is shown as an example.

Before the first wedge prism 710 and the second wedge prism 720 move in the short axis direction SA, the amount of the laser beam LSR that overlaps the first wedge prism 710 may be the same as the amount of the laser beam LSR that overlaps the second wedge prism 720. Therefore, the amount of the laser beam LSR refracted by the first wedge prism 710 may be the same as the amount of the laser beam LSR refracted by the second wedge prism 720.

Therefore, as shown in FIG. 18, the intensity of the energy density of the first energy enhancement area EHA1 and the second energy enhancement area EHA2, which are respectively formed by the first wedge prism 710 and the second wedge prism 720, may be higher than the intensity of the energy density of the flat top area FTA as much as a first size H1. The intensity of the energy density of the first energy weakening area EWA1 and the second energy weakening area EWA2, which are respectively formed by the first wedge prism 710 and the second wedge prism 720, may be lower than the intensity of the energy density of the flat top area FTA as much as the first size H1.

On the other hand, when the first wedge prism 710 moves in the short axis direction SA, the amount of the laser beam LSR that overlaps the first wedge prism 710 may be less than the amount of the laser beam LSR that overlaps the second wedge prism 720. Therefore, the amount of the laser beam LSR refracted by the first wedge prism 710 may be less than the amount of the laser beam LSR refracted by the second wedge prism 720.

Therefore, as shown in FIG. 18, the intensity of the energy density in the first energy enhancement area EHA1 formed by the first wedge prism 710 may be higher than the intensity of the energy density in the flat top area FTA as much as a second size H2. The intensity of the energy density in the first energy weakening area EWA1 formed by the first wedge prism 710 may be lower than the intensity of the energy density in the flat top area FTA as much as the second size H2. The second size H2 may be smaller than the first size.

Because the active area AA, the protruded area A and the boundary area BR have their respective transmissive rates different from one another for each display device DD to be manufactured, the intensity of the energy enhancement area EHA also needs to be changed in accordance with the display device DD.

The laser lift-off apparatus 1 according to some embodiments may easily adjust the intensity of the energy density of the energy enhancement area EHA by adjusting the amount of the laser beam LSR, which overlaps the wedge prism 700, by adjusting the position of the wedge prism 700 in the short axis direction SA. Therefore, the intensity of the energy density of the energy enhancement area EHA may be adjusted by a method such as adjusting the position of the wedge prism 700 in the short axis direction SA by providing a separate driving unit without replacing the wedge prism 700 for each display device DD to be manufactured.

Hereinafter, further details of a laser lift-off apparatus according to some embodiments will be described. In the following description, the same reference numerals will be given to the same elements as those of the previously described embodiments and their redundant description will be omitted or simplified, and the following description will be based on differences from the previously described embodiments.

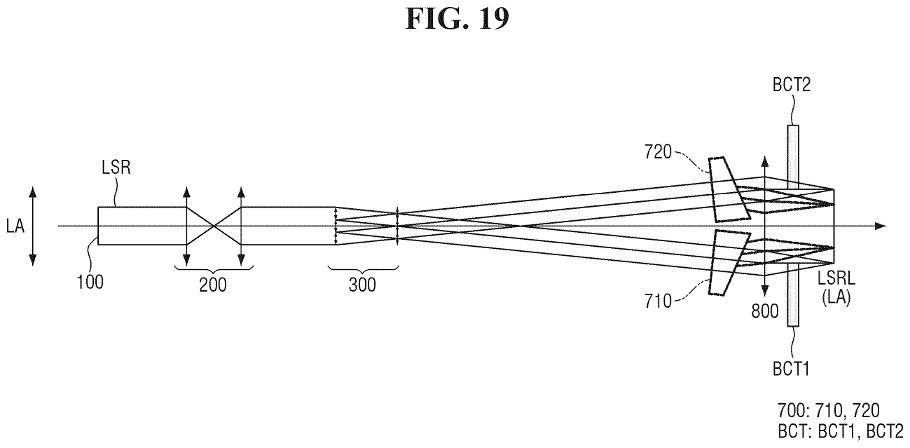

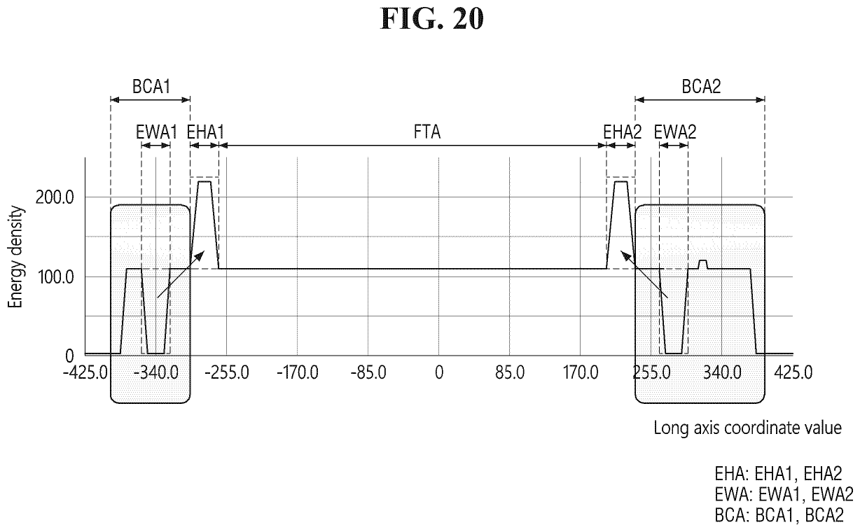

FIG. 19 is a schematic view illustrating a moving path of a laser beam in a long axis direction of a laser lift-off apparatus according to some embodiments. FIG. 20 is a schematic view illustrating an energy profile of a final laser beam of a laser lift-off apparatus according to some embodiments.

Referring to FIGS. 19 and 20, the laser lift-off apparatus 1 according to the present embodiments differs from the laser lift-off apparatus 1 according to the embodiments described with reference to FIG. 5 and the like in that it further includes a beam cutter BCT.

In more detail, the laser lift-off apparatus 1 according to some embodiments may further include a beam cutter BCT. The beam cutter BCT may reflect or absorb the laser beam LSR incident on the beam cutter BCT to block a path of the laser beam LSR incident on the beam cutter BCT.

The beam cutter BCT may be positioned between the wedge prism 700 and the image plane. The beam cutter BCT may be arranged to overlap a path of the laser beam LSR incident on an outer area of the energy enhancement area EHA.

In some embodiments, the beam cutter BCT may include a first beam cutter BCT1 and a second beam cutter BCT2. The first beam cutter BCT1 and the second beam cutter BCT2 may be spaced apart from each other in the long axis direction LA. The first beam cutter BCT1 may be located on one side of the first wedge prism 710 in a moving direction of the laser beam LSR, and the second beam cutter BCT2 may be located on one side of the second wedge prism 720 in the moving direction of the laser beam LSR.

The final laser beam LSRL may include a beam cancellation area BCA in the energy profile. The beam cancellation area BCA may be an area formed by blocking the laser beam LSR through the beam cutter BCT.

The beam cancellation area BCA may include a first beam cancellation area BCA1 and a second beam cancellation area BCA2. The first beam cancellation area BCA1 may be an area formed by blocking the laser beam LSR through the first beam cutter BCT1, and the second beam cancellation area BCA2 may be an area formed by blocking the laser beam LSR through the second beam cutter BCT2.

The beam cancellation area BCA may be positioned outside the energy enhancement area EHA. For example, the beam cancellation area BCA may be positioned at an opposite side of the flat top area FTA with the energy enhancement area EHA interposed therebetween. The first beam cancellation area BCA1 may be located outside the first energy enhancement area EHA1, and the second beam cancellation area BCA2 may be located outside the second energy enhancement area EHA2.

The beam cancellation area BCA may have an energy density lower than that of the energy enhancement area EHA. For example, the energy density of the final laser beam LSRL in the energy enhancement area EHA may be 0, but embodiments according to the present disclosure are not limited thereto.

Although FIG. 20 shows that the energy density in a portion of the beam cancellation area BCA is higher than 100, this is only an example of FIG. 15 for convenience of explanation. As in the embodiments illustrated and described with respect to FIG. 15, when the energy density is present in an unnecessary area outside the energy enhancement area EHA, a beam cancellation area may be arranged to cancel such an unnecessary energy density. In this case, the energy density of the beam cancellation area BCA may be substantially close to 0.

The laser lift-off apparatus 1 according to some embodiments may relatively improve reliability of the laser lift-off process by attenuating energy in the unnecessary area by using the beam cutter BCT.

In concluding the detailed description, those skilled in the art will appreciate that many variations and modifications can be made to the disclosed embodiments without substantially departing from embodiments according to the principles of the present disclosure. Therefore, the disclosed embodiments of the invention are used in a generic and descriptive sense only and not for purposes of limitation.

What is claimed is:

1. A laser lift-off apparatus configured to convert a first beam into a second beam having a width in a short axis direction and a long axis direction, the laser lift-off apparatus comprising:
a laser beam generator generating the first beam;
a homogenizer homogenizing the first beam; and
a wedge prism refracting at least a portion of the first beam passing through the homogenizer,
wherein a beam profile of the second beam includes a first area and a second area having energy higher than that of the first area.

2. The laser lift-off apparatus of claim 1, wherein the wedge prism includes a first wedge prism and a second wedge prism, which are spaced apart from each other in the long axis direction.

3. The laser lift-off apparatus of claim 2, wherein the second area includes a first sub-area and a second sub-area, which are on their opposite sides with the first area interposed therebetween,
the first sub-area is an area formed by the first beam passing through the first wedge prism, and
the second sub-area is an area formed by the first beam passing through the second wedge prism.

4. The laser lift-off apparatus of claim 1, wherein the beam profile of the second beam includes a third area opposite to the first area with the second area interposed therebetween, and
the third area has energy lower than that of the first area.

5. The laser lift-off apparatus of claim 4, wherein an energy difference between the first area and the second area is equal to an energy difference between the first area and the third area.

6. The laser lift-off apparatus of claim 1, wherein a position of the second area in the beam profile of the second beam is determined by a position of an area where the first beam incident on the wedge prism overlaps the wedge prism.

7. The laser lift-off apparatus of claim 1, wherein energy intensity of the second area in the beam profile of the second beam is determined by a size of an area where the first beam incident on the wedge prism overlaps the wedge prism.

8. The laser lift-off apparatus of claim 1, further comprising a telescope lens between the laser beam generator and the homogenizer, and configured to transmit the first beam through enlargement or the same magnification.

9. The laser lift-off apparatus of claim 8, further comprising a short axis slit between the homogenizer and the wedge prism, and configured to transmit a portion of the first beam in the short axis direction.

10. The laser lift-off apparatus of claim 9, further comprising a short axis Fourier lens between the homogenizer and the short axis slit, and configured to allow the first beam transmitted through the telescope lens to be focused on the short axis slit along the short axis direction.

11. The laser lift-off apparatus of claim 9, further comprising a long axis Fourier lens between the wedge prism and an image plane on which the second beam is incident, and configured to allow the first beam transmitted through the telescope lens to be focused on the image plane.

12. The laser lift-off apparatus of claim 11, further comprising a short axis projection lens between the wedge prism and the image plane on which the second beam is incident, and configured to adjust a width of the first beam, which has passed through the short axis slit, in the short axis direction.

13. The laser lift-off apparatus of claim 1, further comprising a beam cutter between the wedge prism and an image plane on which the second beam is incident, and configured to block a path of the first beam incident on an outer area of the second area.

14. The laser lift-off apparatus of claim 13, further comprising a beam cancellation area outside the second area, wherein energy intensity of the beam cancellation area is lower than that of the second area.

15. The laser lift-off apparatus of claim 1, wherein a profile shape of the second beam in the first area and the second area is a flat top shape.

16. A method of lifting-off substrate, the method comprising:
lifting-off a carrier substrate from a first substrate by irradiating a laser generated from a laser lift-off apparatus to a display device, the display device comprising:
the carrier substrate;
the first substrate on the carrier substrate;
a barrier layer on the first substrate; and
a second substrate on the barrier layer, wherein
the barrier layer is larger than the first substrate in a plan view,
the display device includes an active area in which pixels are located, and a protruded area in which the barrier layer does not overlap the first substrate, and
energy intensity of the laser irradiated to the active area is lower than that of the laser irradiated to the protruded area.

17. The method of claim 16, wherein
the laser includes a first beam and a second beam,
the laser lift-off apparatus converts the first beam into the second beam having
a width in a short axis direction and a long axis direction,
the laser lift-off apparatus includes:
a laser beam generator generating the first beam;
a homogenizer homogenizing the first beam; and
a wedge prism refracting at least a portion of the first beam passing through the homogenizer, and
a beam profile of the second beam includes a first area and a second area having energy higher than that of the first area.

18. The method of claim 17, wherein the second beam of the first area is irradiated to the active area, and the second beam of the second area is irradiated to the protruded area.

19. The method of claim 17, wherein a position of the second area in the beam profile of the second beam is determined by a position of an area where the first beam incident on the wedge prism overlaps the wedge prism.

20. The method of claim 17, wherein energy intensity of the second area in the beam profile of the second beam is determined by a size of an area where the first beam incident on the wedge prism overlaps the wedge prism.
